(19) United States
(12) Patent Application Publication
(10) Pub. No.: US 2016/0244327 A1
(43) Pub. Date: Aug. 25, 2016

(54) METHOD AND PLANT FOR GASIFYING INPUT MATERIAL

(71) Applicant: LINDE AKTIENGESELLSCHAFT, München (DE)

(72) Inventors: Thomas Heidrich, Niederschöna (DE); Gerald Gaube, Dresden (DE); Jens Buschmann, Dresden (DE)

(21) Appl. No.: 15/030,608

(22) PCT Filed: Oct. 7, 2014
(86) PCT No.: PCT/EP2014/002719

§ 371 Date: Apr. 20, 2016

(30) Foreign Application Priority Data
Oct. 22, 2013 (DE) 102013017546.1

(51) Int. Cl. C01B 3/02; C10B 57/14; C10B 53/02; C10B 27/00

(52) U.S. Cl. CPC C01B 3/02; C10B 27/00; C10B 57/14; C10B 53/02

(57) ABSTRACT

The invention relates to a plant for at least partly gasifying solid organic input material, with a low-temperature gasifier in which pyrolysis can yield a tar-containing pyrolisis gas from a solid organic input material, and with a high-temperature gasifier having an oxidation unit and an endothermic gasifier, where the pyrolisis gas can be converted to a synthesis gas by partial oxidation in the oxidation unit followed by partial reduction in the endothermic reactor, said endothermic reactor having a form which widens conically in the vertical direction and which has at least one side offtake to take off unwanted particulate solids at not less than one height, more particularly at not less than two or more different heights.

The present invention relates to a method and a plant for at least partially gasifying solid, organic input material, in particular biomass, having a low-temperature gasifier and a high-temperature gasifier.

### PRIOR ART

Methods for producing synthesis gas from solid, organic input material, also referred to as gasifying methods, are known. Coal or biomass is advantageously used as the input material for such methods. In biomass gasifying methods, used wood and forest waste wood or what are known as energy woods, but also agricultural wastes such as straw or chaff, are used for example.

Gasification of biomass to form synthesis gas with subsequent method steps (what are known as biomass-to-liquid or BTL methods) can be used for example to obtain synthetic biofuel that has similar physicochemical properties to known gas-to-liquid (GTL) and coal-to-liquid (CTL) fuels. One example of a plant for producing Bit fuels is disclosed in Kiener, C. and Bilas, 1.: Synthetic second-generation biofuel. The first commercial Mt production plant in the world. Energy 2.0, July 2008, pages 42-44.

Methods and plants for at least partially gasifying solid, organic input material are also known for example from EP 0 745 114 B1, DE 41 39 512 A1 and DE 42 09 549 A1 The present application relates to such methods and plants that have a low-temperature gasifier and a high-temperature gasifier, as explained below. Compared with other methods, these allow, inter alia, lower consumption of input material and have a higher cold gas efficiency.

In a low-temperature gasifier, the input material, for example biomass, is converted by partial gasification with a gasifying agent at temperature between approx. 300° C. and 600° C. into coke (in the case of biomass into what is known as biocoke) and pyrolysis gas.

The conversion is referred to as “pyrolysis” in the present application. Pyrolysis is known to have an under-stoichiometric oxygen supply and therefore incomplete combustion at comparatively low temperature.

The pyrolysis gas is then transferred to a combustion chamber of the high-temperature gasifier and partially oxidised there with an oxygen-containing gas, for example with more or less pure oxygen, but also with air and/or oxygen-containing waste gases, e.g. from gas turbines or internal combustion engines. Heat released by said oxidation causes an increase in temperature to between 1200° C. and 2000° C., for example 1400° C. Under such conditions, aromatics, tars and oxo compounds in the pyrolysis gas are completely decomposed. A synthesis gas that consists substantially of only carbon monoxide, hydrogen, carbon dioxide and steam is formed thereby. The synthesis gas can also be referred to as (synthesis) raw gas at this point.

In a further stage, for example in a quenching unit integrated in the high-temperature gasifier or connected downstream thereto, the synthesis gas produced in this manner is brought into contact with coke from the low-temperature gasifier. The coke can be prepared separately beforehand (e.g. by grinding and sieving) and then introduced into the quenching unit. The synthesis gas is cooled to approximately 900° C. by endothermic reactions between the coke and the synthesis gas. This effects a partial conversion of the carbon dioxide into carbon monoxide.

The synthesis gas rich in carbon monoxide produced in this manner can then be further conditioned. Conditioning comprises for example further cooling, dedusting, compression and/or removal of residual carbon dioxide.

Previously, it had to be ensured when selecting the input materials that the fraction of solid and/or inert foreign materials such as sand did not exceed a certain maximum value, to be able to guarantee that excessive amounts of such foreign materials did not accumulate in the gasifier. In previous plants, it was necessary to shut down the gasifier and remove these solids manually if an excessively large accumulation was found.

There is therefore a need for improvements in the operation of such plants. In particular, it should be made possible for such plants to be operated with less strict requirements for the input materials to be free from sand.

### DISCLOSURE OF THE INVENTION

The invention proposes a plant and a method are proposed for at least partially gasifying solid, organic input material, in particular biomass, having the features of the independent claims. Preferred embodiments form the subject matter of the dependent claims and of the following description.

### Advantages of the Invention

The invention proceeds from a known method for at least partially gasifying solid, organic input material, for example biomass. A tar-containing pyrolysis gas is produced from the input material by pyrolysis in a low-temperature gasifier. The pyrolysis gas is then converted into a synthesis gas by partial oxidation in a high-temperature gasifier and then by partial oxidation and subsequent partial reduction in an endothermic reactor or gasifier, which can be part of the high-temperature gasifier. According to the invention, it can be ensured in a simple manner for solid (undesirable) foreign materials, which are primarily introduced by the pyrolysis coke, in the synthesis gas to be removed from the synthesis gas flow. This makes it possible to use less pure input materials, in particular, less strict requirements for freedom from sand (that is, tolerance of input materials having correspondingly higher quartz and silicon fractions) can be tolerated while avoiding the accumulation of such foreign materials and in particular the formation of melt phases of alkali silicates.

The side offtakes provided according to the invention can be implemented simply in design terms at a desired level or desired different levels in an endothermic gasifier.

Advantageously, the at least one level for a side offtake is selected taking into account the cross section of the endothermic reactor at said level and a flow speed produced thereby of the synthesis gas flowing upwards through the endothermic gasifier and a determined or expected size of the foreign particles to be extracted.

In particular, the invention exploits the fact that for example undesirable (inert) sand particles have an average particle size (particle diameter). The flow speed of the synthesis gas flowing upwards in the endothermic gasifier decreases towards the top owing to the conical widening of the gasifier. In a lower region of the endothermic gasifier, the (upward) force acting on the foreign particles by the flow is relatively large and exceeds the weight force of the particles. At a certain level of the endothermic gasifier, these two forces cancel each other out, and therefore an increased concentration of said undesirable particles occurs at said level. A side offtake is expediently provided at this level.

It is preferred for the at least one side offtake to be operatively connected to a vacuum pump, in particular a jet pump. Such vacuum pumps can be used to extract undesirable foreign materials from the endothermic gasifier in a simple manner.

### BRIEF DESCRIPTION OF THE DRAWINGS

FIG. 1 shows a schematic diagram of a plant that is designed for carrying out a method according to the invention, and

FIG. 2 shows a preferred embodiment of part of a plant according to the invention.

### EMBODIMENT OF THE INVENTION

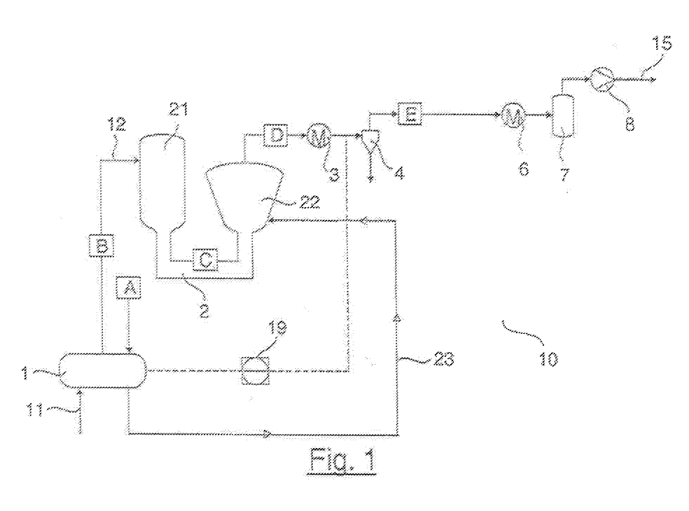

FIG. 1 shows a plant that is designed to carry out a method according to the invention can is referred to as a whole with 10. The plant 10 comprises a low-temperature gasifier 1 and a high-temperature gasifier 2.

An input material A, for example biomass such as wood or corresponding wastes as explained above, can be fed into the low-temperature gasifier 1. Oxygen can be fed in for example via a line 11. The low-temperature gasifier 1 is designed for pyrolysis of the solid, organic input material A.

A pyrolysis gas B can be discharged from the low-temperature gasifier 1 via a line 12 and transferred to the high-temperature gasifier 2. The high-temperature gasifier 2 is in two parts. It comprises an oxidation unit 21 and an endothermic reactor (quenching unit) 22. In the oxidation unit 21, the pyrolysis gas B is partially oxidised with a supplied oxygen-containing gas, producing temperatures of for example 1400° C. to 2000° C., as explained. This produces a synthesis gas, which is referred to with C.

The synthesis gas C is transferred to the endothermic reactor 22 via a fluid connection between the oxidation unit 21 and the endothermic reactor/gasifier 22. Ground coke, in particular pyrolysis coke from the low-temperature gasifier 1, is introduced into said reactor. A line via which pyrolysis coke is introduced into the endothermic reactor is referred to with 23. The endothermic reactions resulting therefrom cause the gas temperature to cool rapidly to approx. 900° C.; an at least partial reduction occurs.

The obtained gas mixture D, which is still referred to as synthesis gas (now rich in carbon monoxide), is fed to a cooler 3 and cooled there to a temperature of for example 600° C. The synthesis gas D can then be dedusted in a cyclone 4. The dedusted synthesis gas E, also referred to in the present application as “gas mixture derived from the synthesis gas”, now has a temperature of for example 500° C. and can be cooled in a further cooler 6. Said gas can then be fed for example to a carbon dioxide removal device 7.

Downstream of the carbon dioxide removal device 7, a gas mixture received in said device can for example be compressed in a compressor 8.

The gas flow is discharged from the plant 10 via a line 15. To ensure a sufficient pressure gradient and therefore to prevent back-flow, the plant 10 expediently has a pressure regulator 19 with actuators (not shown).

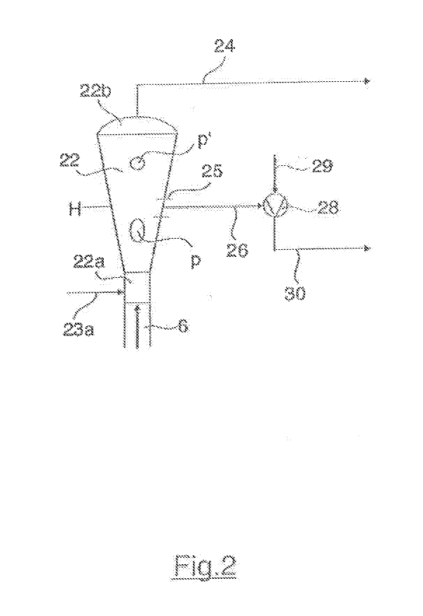

The endothermic reactor (quenching unit) 22 has a shape that widens conically towards the top, as indicated in FIG. 1 and shown in detail in FIG. 2. Said endothermic reactor will now be explained in more detail with reference to FIG. 2. It should be noted that the details discussed here can likewise be implemented in the plant according to FIG. 1.

The synthesis gas flow indicated with C in FIG. 1 is deflected 90 degrees upwards, i.e. into the vertical, for example in a deflection chamber (not shown). The synthesis gas therefore flows substantially vertically upwards through the endothermic gasifier 22, which widens conically towards the top. The ground coke from the low-temperature gasifier 1 that is used for the reduction is introduced for example in the lower region 22a of the endothermic reactor 22, for example via a screw conveyor (shown symbolically by arrow 23a) operatively connected to the line 23. Said pyrolysis coke reacts in the described manner with the synthesis gas C, the particle size of the pyrolysis coke particles decreasing with increasing reaction, that is, with increasing dwell time inside the endothermic gasifier 22 (symbolised by two schematically shown particles p, p′).

Undesirable foreign particles such as sand grains, which are introduced into the endothermic reactor primarily by the pyrolysis coke, are however inert and substantially do not react inside the endothermic reactor 22, and therefore retain their particle size.

In the lower region 22a of the endothermic reactor 22, said foreign particles are entrained upwards owing to the relatively high flow speed of the raw synthesis gas. However, owing to the conical widening of the endothermic reactor, the flow speed of the synthesis as slows, and therefore a level H inside the reactor 22 can be calculated and/or determined at which the weight force of the foreign particles (sand grains) compensates the upward force exerted by the flow of the synthesis gas. An accumulation or concentration of the foreign particles occurs at said level.

The endothermic gasifier is provided with a side offtake 25 at or in the region of said level H. The side offtake 25 is connected to a jet pump 28 via a line (symbolised with arrow 26). In this case for example water is used as the pump medium, which is introduced into the jet pump via a line 29 and exits it via a line 30. The vacuum produced by means of the jet pump causes the particles or foreign particles concentrated at the level H be extracted from the endothermic reactor and removed from the system with the water via the line 30.

It cannot be completely excluded that a small fraction of synthesis gas and also pyrolysis coke particles are extracted together with the foreign particles. The fraction is however very low compared with the synthesis gas fraction that exits the endothermic reactor via the line 24. The materials extracted via the line 30 can be separated from each other in a suitable manner and fed hack into the system where appropriate.

The jet pump 28 expediently carries out a full quench for the extracted mass flow. The amount of the mass flow extracted at the side can be set variably by setting the vacuum produced by the pump 28.

The plant according to the invention can continue operating without interruptions when accumulations of inert solid particles such as sand occur, by corresponding actuation of the jet pump 28. In particular, such a side offtake prevents the formation of melt phases, such as of alkali silicates. Overall, the requirements for purity of the input material of the gasification are significantly reduced according to the invention.

Instead of a jet pump (water jet pump) with water as the drive medium, a jet compressor (gas jet pump) with for example steam or CO2 as the drive medium can be used as the vacuum pump.

To prevent melt gases, additives such as kaolin, limestone or dolomite can also be added to the endothermic gasifier. The overall mixture can then be extracted again at the side without sticky particles forming.

A side offtake can also be provided on comparable entrained reactors, which are used for endothermic quenching.

1. A plant for at least partially gasifying solid, organic input material, having a low-temperature gasifier, in which a tar-containing pyrolysis gas can be obtained by pyrolysis from a solid, organic, input material, and a high-temperature gasifier, which has an oxidation unit and an endothermic gasifier, wherein the pyrolysis gas can be converted into a synthesis gas by partial oxidation in the oxidation unit and subsequent partial reduction in the endothermic reactor, wherein the endothermic reactor has a shape that widens conically in the vertical direction and has at least one side offtake for extracting undesirable solid particles at least at one level, in particular at least at two or more different levels.

2. The plant according to claim 1, in which the at least one level is selected taking into account: the cross section of the endothermic reactor at said level; a flow speed of the upwardly flowing synthesis gas resulting therefrom at said level; and a determined or expected size of the undesirable solid particles.

3. The plant according to claim 1, characterised in that the at least one side offtake is operatively connected to a vacuum pump.

4. The plant according to claim 3, characterised in that the vacuum pump is in the form of a jet pump or jet compressor.

5. A method for at least partially gasifying solid, organic input material, Wherein a tar-containing pyrolysis gas is obtained by pyrolysis from the input material in a low-temperature gasifier and the pyrolysis gas is then partially oxidised in an oxidation unit of a high-temperature gasifier and then converted to a synthesis gas by partial reduction in an endothermic reactor of the high-temperature gasifier, wherein the endothermic reactor has a shape that widens conically in the vertical direction, wherein synthesis gas flows through the endothermic reactor in a substantially vertical direction from bottom to top, and undesirable solid particles introduced into the synthesis gas primarily h the pyrolysis coke are extracted via at least one side offtake provided at a level.

6. The method according to claim 5, characterised in that the undesirable solid particles are extracted from the endothermic reactor by means of a vacuum provided at the side offtake.

7. The plant according to claim 1, characterised in that undesirable solid particles are extracted at least at two or more different levels.
